(19) United States
(12) Patent Application Publication
(10) Pub. No.: US 2024/0394309 A1
(43) Pub. Date: Nov. 28, 2024

(54) CAUSAL GRAPH CHAIN REASONING PREDICTIONS

(71) Applicant: Honda Motor Co., Ltd., Tokyo (JP)

(72) Inventors: Aolin XU, Santa Clara, CA (US); Enna SACHDEVA, San Jose, CA (US); Yichen SONG, Ann Arbor, MI (US); Teruhisa MISU, San Jose, CA (US); Behzad DARIUSH, San Ramon, CA (US); Kikuo FUJIMURA, Palo Alto, CA (US); Kentaro YAMADA, Tokyo (JP)

(21) Appl. No.: 18/323,027

(22) Filed: May 24, 2023

(51) Int. Cl. G06F 16/901

(52) U.S. Cl. CPC G06F 16/9024

(57) ABSTRACT

According to one aspect, causal graph chain reasoning predictions may be implemented by generating a causal graph of one or more participants within an operating environment including an ego-vehicle, one or more agents, and one or more potential obstacles, generating a prediction for each participant within the operating environment based on the causal graph, and generating an action for the ego-vehicle based on the prediction for each participant within the operating environment. Nodes of the causal graph may represent the ego-vehicle or one or more of the agents. Edges of the causal graph may represent a causal relationship between two nodes of the causal graph. The causal relationship may be a leader-follower relationship, a trajectory-dependency relationship, or a collision relationship.

### BACKGROUND

A traffic collision, also called a motor vehicle collision, occurs when a vehicle collides with another vehicle, pedestrian, animal, road debris, or other moving or stationary obstruction, such as a tree, pole, or building. Traffic collisions may result in damage as well as financial costs to both society and the individuals involved. Road transport is a common situation people deal with on a daily basis. A number of factors contribute to collisions, including vehicle design, speed of operation, road design, weather, road environment, driving skills, impairment due to alcohol or drugs, and behavior, notably aggressive driving, distracted driving, speeding, and street racing.

### BRIEF DESCRIPTION

According to one aspect, a system for causal graph chain reasoning predictions may include a processor and a memory. The memory may store one or more instructions. The processor may execute one or more of the instructions stored on the memory to perform one or more acts, actions, or steps, such as generating a causal graph of one or more participants within an operating environment including an ego-vehicle, one or more agents, and one or more potential obstacles, generating a prediction for each participant within the operating environment based on the causal graph, and generating an action for the ego-vehicle based on the prediction for each participant within the operating environment.

One or more of the agents may be another vehicle, a bicycle, or a motorcycle. One or more of the potential obstacles may be another vehicle, a bicycle, a motorcycle, a parked vehicle, a traffic sign, a pedestrian, an intersection, or a road feature. One or more nodes of the causal graph may represent the ego-vehicle or one or more of the agents. One or more edges of the causal graph may represent a causal relationship between two nodes of the causal graph. The causal relationship may be a leader-follower relationship, a trajectory-dependency relationship, or a collision relationship. The prediction for each participant may be an intention prediction or a trajectory prediction. The generating the prediction for each participant within the operating environment may be based on a topological sort of the causal graph. The action may be a warning to be provided by a vehicle system. The action may be a driving maneuver to be implemented by a vehicle system.

According to one aspect, a computer-implemented method for causal graph chain reasoning predictions may include generating a causal graph of one or more participants within an operating environment including an ego-vehicle, one or more agents, and one or more potential obstacles, generating a prediction for each participant within the operating environment based on the causal graph, and generating an action for the ego-vehicle based on the prediction for each participant within the operating environment.

One or more nodes of the causal graph may represent the ego-vehicle or one or more of the agents. One or more edges of the causal graph may represent a causal relationship between two nodes of the causal graph. The causal relationship may be a leader-follower relationship, a trajectory-dependency relationship, or a collision relationship. The prediction for each participant may be an intention prediction or a trajectory prediction. The generating the prediction for each participant within the operating environment may be based on a topological sort of the causal graph.

According to one aspect, a system for causal graph chain reasoning predictions may include a processor and a memory. The memory may store one or more instructions. The processor may execute one or more of the instructions stored on the memory to perform one or more acts, actions, or steps, such as generating a causal graph of one or more participants within an operating environment including an ego-vehicle, one or more agents, and one or more potential obstacles, generating an intention prediction or a trajectory prediction for each participant within the operating environment based on the causal graph, and generating an action for the ego-vehicle based on the prediction for each participant within the operating environment.

One or more nodes of the causal graph may represent the ego-vehicle or one or more of the agents. One or more edges of the causal graph may represent a causal relationship between two nodes of the causal graph. The causal relationship may be a leader-follower relationship, a trajectory-dependency relationship, or a collision relationship.

### BRIEF DESCRIPTION OF THE DRAWINGS

FIG. 1 is an exemplary component diagram of a system for causal graph chain reasoning predictions, according to one aspect.

FIG. 2 is an exemplary flow diagram of a computer-implemented method for causal graph chain reasoning predictions, according to one aspect.

FIG. 3 is an exemplary illustration of a scenario associated with the system for causal graph chain reasoning predictions of FIG. 1, according to one aspect.

FIGS. 4A-4F are exemplary illustrations of scenarios associated with the system for causal graph chain reasoning predictions of FIG. 1, according to one aspect.

FIG. 5 is an illustration of an example computer-readable medium or computer-readable device including processor-executable instructions configured to embody one or more of the provisions set forth herein, according to one aspect.

FIG. 6 is an illustration of an example computing environment where one or more of the provisions set forth herein are implemented, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle or ego-vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

An “agent”, as used herein, may be a machine that moves through or manipulates an environment. Exemplary agents may include robots, vehicles, or other self-propelled machines. The agent may be autonomously, semi-autonomously, or manually operated.

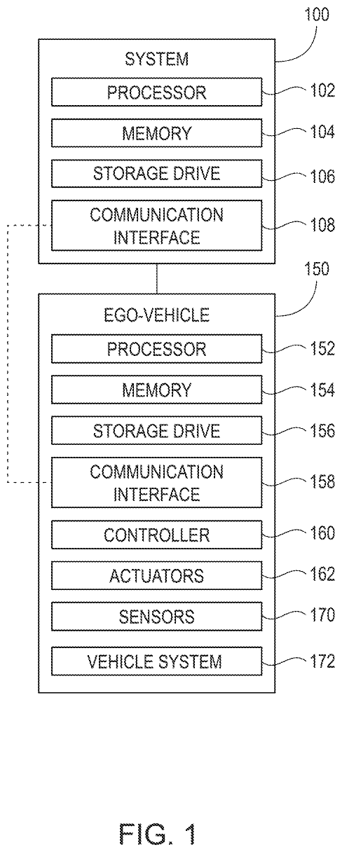

FIG. 1 is an exemplary component diagram of a system 100 for causal graph chain reasoning predictions, according to one aspect. The system 100 for causal graph chain reasoning predictions may be implemented on-board a vehicle or remotely from the autonomous vehicle, such as on a mobile device, for example. The system 100 for causal graph chain reasoning predictions may include a processor 102, a memory 104, a storage drive 106, and a communication interface 108. The ego-vehicle 150 may include a processor 152, a memory 154, a storage drive 156, a communication interface 158, a controller 160, actuators 162, sensors 170, and one or more vehicle systems 172.

Although described herein primarily using processor 102, it will be appreciated that any processing, computations, predictions, etc. described herein may be performed by either the processor 102 of the system 100 for causal graph chain reasoning predictions and communicated to the ego-vehicle 150 via the communication interfaces 108, 158 or performed by the processor 152 of the ego-vehicle 150. In this way, the respective components may be communicatively coupled and/or in computer communication with one another.

At a high level, the system 100 for causal graph chain reasoning predictions may receive information regarding a surrounding environment, generate a causal graph representative of aspects of the surrounding environment, and make predictions based on the causal graph. These predictions may be utilized to facilitate a smoother driving or riding experience for occupants of the ego-vehicle 150.

According to one aspect, the system 100 for causal graph chain reasoning predictions may include the processor 102 and the memory 104. The memory 104 may store one or more instructions. The processor 102 may execute one or more of the instructions stored on the memory 104 to perform one or more acts, actions, or steps.

### Causal Graph Generation

The processor 102 may generate a causal graph of one or more participants within an operating environment including an ego-vehicle 150, one or more agents, and one or more potential obstacles based on data received from sensors 170 on the ego-vehicle 150 and/or information received via the communication interface 158, such as via vehicle-to-vehicle (V2V) communications. In any event, this data may include trajectory, velocity, acceleration information etc. related to each participant (e.g., the ego-vehicle 150, agents, potential obstacles, etc.). Within the causal graph, one or more of the agents may be another vehicle, a bicycle, or a motorcycle. One or more of the potential obstacles may be another vehicle, a bicycle, a motorcycle, a parked vehicle, a traffic sign, a pedestrian, an intersection, or a road feature. Thus, agents may be considered potential obstacles as well. One or more nodes of the causal graph may represent the ego-vehicle 150 or one or more of the agents. In this way, the relationships between participants of a traffic scene may be encoded in a graph.

According to one aspect, one or more edges of the causal graph may represent a causal relationship (e.g., cause-effect relationship) between two nodes of the causal graph. The causal relationship may be a leader-follower relationship, a trajectory-dependency relationship, or a collision relationship. Explained in greater detail, the processor 102 may define an edge when a first node or agent A (i.e., one or more of the agents or one or more of the potential obstacles) causes a second node or agent B (i.e., one or more of the other agents or one or more of the other potential obstacles) to change motion or trajectory. Another way of defining an edge point from agent A to agent B, a future trajectory of agent B may depend on a future trajectory of agent A, and thus, y_{B}=f(y_{A}). Yet another example of the causal relationship may be the collision relationship, such as when agent B will collide with agent A if agent B does not change trajectory. A probabilistic interpretation of a generated causal graph which is acyclic may be P_{Y}_{₁}_{,Y}_{₂}_{,Y}_{₃}_{|X}=P_{Y}_{₁}_{|X}P_{Y}_{₂}_{|Y}_{₁}_{,X}P_{Y}_{₃}_{|Y}_{₁}_{,Y}_{₂}_{,X}. These three definitions may be different from one another.

### Prediction Generation Using Graph-Based Reasoning

The processor 102 may generate a prediction for each participant (e.g., thereby locally modeling each participant) within the operating environment based on the causal graph. For example, a local model may mean a predictive model for each node or each agent in the causal graph. The prediction for each participant within the operating environment may be based on a topological sort of the nodes of the causal graph which is acyclic, thereby enabling top-down reasoning. Once the causal graph is topologically sorted, the directed acyclic graph (DAG) has a property such that each node has a smaller index than the node's descendants. Due to this property of the DAG, prediction of each node may be performed sequentially since a node's parent's behaviors may already be predicted. In other words, once local models are obtained for each node, the local models may be combined, and top down reasoning may be performed to achieve a global inference or global reasoning.

When the causal graph is cyclical, interactions may be considered using a lane change feasibility check which may affect a probability of deviation and an amount of deceleration. For example, the initial predicted lane change probability may be discounted according to the distance between the agent under prediction and its potential follower after deviation. The closer they are, the more the probability will be discounted.

The prediction for each participant may be an intention prediction or a trajectory prediction. The intention prediction may be based on an intelligent driver model (IDM) which is a probabilistic model and may give the intention prediction as an intention to slow down, an intention to deviate lanes or positions with a lane, an intention to accelerate, an intention to decelerate, an intention to stop, an intention to drift left, an intention to drift right, an intention to turn left, an intention to turn right, etc. According to one aspect, this may be given by P[deviate|scenario]=σ(β(IDM headway−actual headway−default)) or P[deviate|scenario]=σ(β(IDM deceleration−default)). For example, the default values may be empirical thresholds of acceleration or headway that cause the following vehicle to deviate when the thresholds are exceeded.

For trajectory prediction, a deviation trajectory may be calculated based on a planned trajectory, which may be decomposed into a lateral movement and a longitudinal movement, each modeled as a polynomial in time. Additionally, boundary conditions may be applied, such as an amount of lateral deviation, a time to complete deviation, etc. These boundary conditions may be set as tunable parameters for the model and may be specified or learned. In this way, the processor 102 may generate a behavior model for each participant or agent within the operating environment to facilitate latent and chain reaction predictions related to the causal graph. Stated another way, the processor 102 may monitor participants within the operating environment (including the ego-vehicle 150, one or more agents, and one or more potential obstacles) and identify one or more of the potential obstacles which may cause one or more of the agents to deviate from a current trajectory, thereby impacting the ego-vehicle 150 via a chain reaction.

One advantage of the use of the causal graphs herein is that a warning generated may also include an explanation of a causal chain or chain reaction (e.g., which may not necessarily be apparent to occupants of the ego-vehicle 150), thereby increasing trust of the occupants or driver with regard to the ego-vehicle 150. A neural network, on the other hand, may be model free, and thus, more difficult to generate an explanation for the occupants. Since the boundary conditions may be set as tunable parameters, this model may be flexible as to a balance between warning frequency and mis-predictions.

Additionally, the processor 102 may estimate whether or not or a likelihood that a collision may occur between the ego-vehicle 150 and one or more of the other agents or between one or more of the other agents and one or more of the potential obstacles. This likelihood of collision may be determined by checking to see if a collision would occur if the ego-vehicle 150 does not change its driving behavior or trajectory and considering the ego-vehicle 150's parent nodes within the causal graph (e.g., immediate leader's predicted behavior).

### Action Generation

The processor 102 may generate an action for the ego-vehicle 150 based on the prediction for each participant within the operating environment. The action may be a warning to be provided by one or more vehicle systems 172 (e.g., speaker, display, tactile device), a driving maneuver to be implemented by the controller 160, actuators 162, one or more vehicle systems 172 (e.g., which may be an autonomous driving system or a driving assistance system), a communication from a first vehicle to a second vehicle using vehicle-to-vehicle (V2V) communication, etc. In this way, latent and chain reactions may be foreseen via the causal graph and predictions and actions may be generated for the ego-vehicle 150 to mitigate collisions which may not necessarily be apparent to occupants of the ego-vehicle 150.

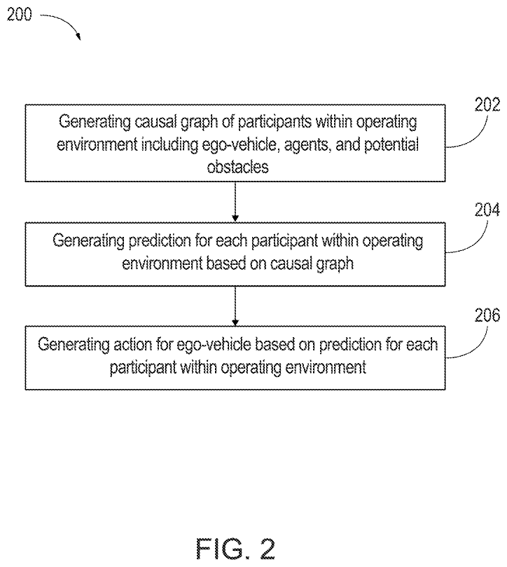

FIG. 2 is an exemplary flow diagram of a computer-implemented method 200 for causal graph chain reasoning predictions, according to one aspect. For example, the computer-implemented method 200 for causal graph chain reasoning predictions may include generating 202 a causal graph of one or more participants within an operating environment including the ego-vehicle 150, one or more agents, and one or more potential obstacles, generating 204 a prediction for each participant within the operating environment based on the causal graph, and generating 206 an action for the ego-vehicle 150 based on the prediction for each participant within the operating environment.

One or more of the agents may be another vehicle, a bicycle, or a motorcycle. One or more of the potential obstacles may be another vehicle, a bicycle, a motorcycle, a parked vehicle, a traffic sign, a pedestrian, an intersection, or a road feature. One or more nodes of the causal graph may represent the ego-vehicle 150 or one or more of the agents. One or more edges of the causal graph may represent a causal relationship between two nodes of the causal graph. The causal relationship may be a leader-follower relationship, a trajectory-dependency relationship, or a collision relationship. The prediction for each participant may be an intention prediction or a trajectory prediction. The generating the prediction for each participant within the operating environment may be based on a topological sort of the causal graph. The action may be a warning to be provided by one or more of the vehicle systems 172. The action may be a driving maneuver to be implemented by one or more of the vehicle systems 172.

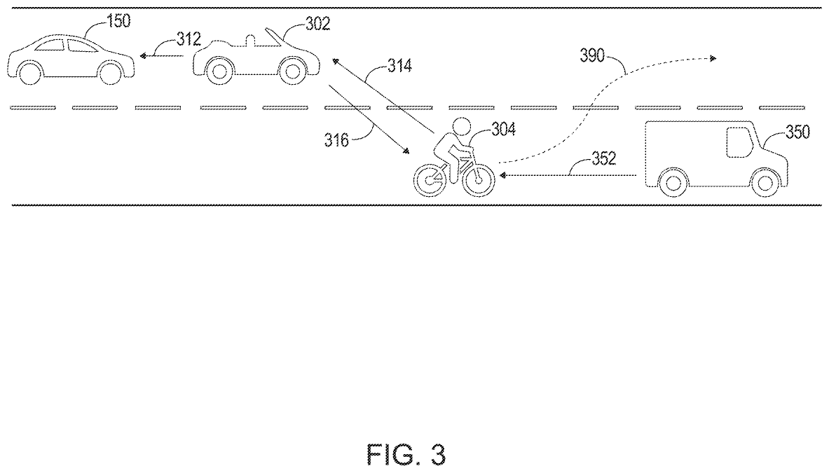

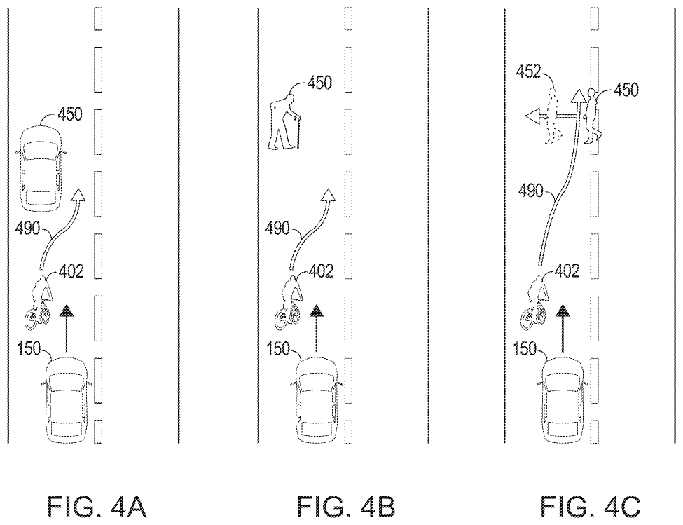

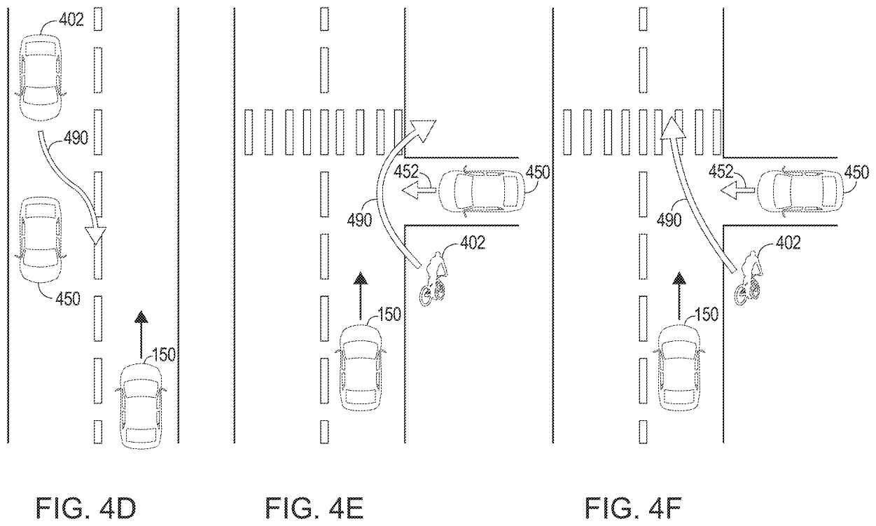

FIG. 3 is an exemplary illustration of a scenario associated with the system 100 for causal graph chain reasoning predictions of FIG. 1, according to one aspect. FIGS. 4A-4F are exemplary illustrations of scenarios associated with the system 100 for causal graph chain reasoning predictions of FIG. 1, according to one aspect.

As seen in FIG. 3, the ego-vehicle 150 is behind another vehicle (e.g., agent 302) which is behind a bicycle (e.g., agent 304) which is behind a parked vehicle (e.g., a potential obstacle 350). Note that agents 302, 304 may also be considered as potential obstacles. A causal graph associated with the traffic scenario of FIG. 3 may have edges 312, 314, 316, 352. Edge 312 may represent agent 302 impact on ego-vehicle 150. Edges 314, 316 may represent the effect that agents 302, 304 have on one another. Edge 352 may represent the impact that the parked vehicle or potential obstacle 350 has on the bicycle or agent 304. The potential obstacle 350 may cause the agent 304 to deviate trajectory 390. This deviated trajectory 390 of agent 304 may cause agent 302 to slow, thereby impacting the ego-vehicle 150. Using the causal graph, predictions, modeling, and action generation described above with reference to the system 100 for causal graph chain reasoning predictions of FIG. 1 may mitigate collisions for the ego-vehicle 150.

FIGS. 4A-4F illustrate different examples of the ego-vehicle 150 being affected by an agent 402 which may be impacted by a potential obstacle 450. The potential obstacle 450 may be static, stationary, dynamic, or moving along a trajectory 452, or changing, for example. This may be seen in FIG. 4C where the pedestrian is walking. In FIG. 4D, the potential obstacle 450 may be an oncoming vehicle. In FIGS. 4E-4F, the potential obstacle 450 may be another vehicle coming to a stop at an intersection prior to moving again. Due to the potential obstacle 450, the agent 402 may deviate trajectory 490, thereby impacting the ego-vehicle 150.

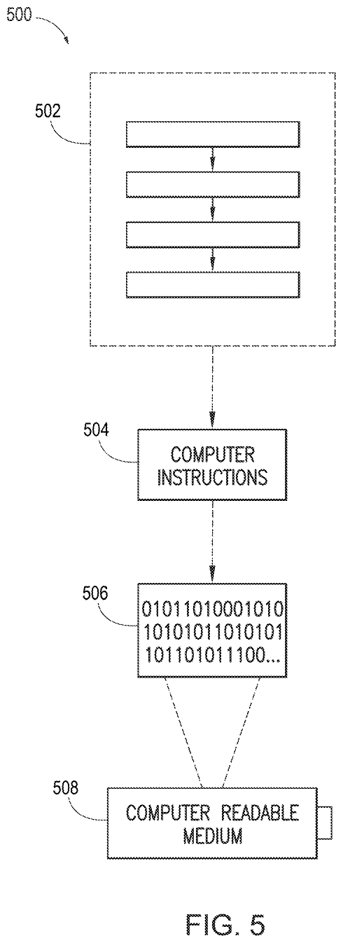

Still another aspect involves a computer-readable medium including processor-executable instructions configured to implement one aspect of the techniques presented herein. An aspect of a computer-readable medium or a computer-readable device devised in these ways is illustrated in FIG. 5, wherein an implementation 500 includes a computer-readable medium 508, such as a CD-R, DVD-R, flash drive, a platter of a hard disk drive, etc., on which is encoded computer-readable data 506. This encoded computer-readable data 506, such as binary data including a plurality of zero's and one's as shown in 506, in turn includes a set of processor-executable computer instructions 504 configured to operate according to one or more of the principles set forth herein. In this implementation 500, the processor-executable computer instructions 504 may be configured to perform a method 502, such as the computer-implemented method 200 of FIG. 2. In another aspect, the processor-executable computer instructions 504 may be configured to implement a system, such as the system 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

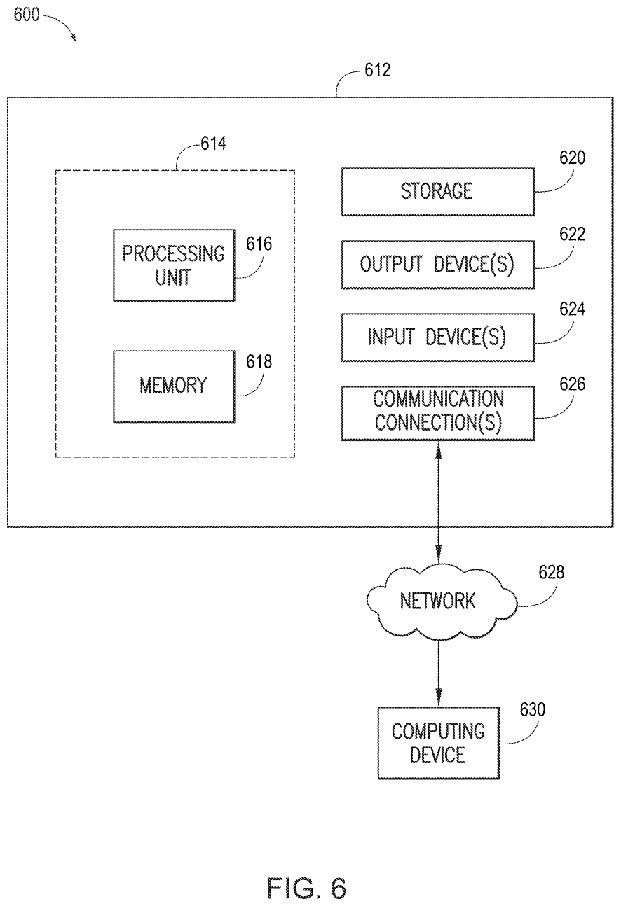

FIG. 6 and the following discussion provide a description of a suitable computing environment to implement aspects of one or more of the provisions set forth herein. The operating environment of FIG. 6 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 6 illustrates a system 600 including a computing device 612 configured to implement one aspect provided herein. In one configuration, the computing device 612 includes at least one processing unit 616 and memory 618. Depending on the exact configuration and type of computing device, memory 618 may be volatile, such as RAM, non-volatile, such as ROM, flash memory, etc., or a combination of the two. This configuration is illustrated in FIG. 6 by dashed line 614.

In other aspects, the computing device 612 includes additional features or functionality. For example, the computing device 612 may include additional storage such as removable storage or non-removable storage, including, but not limited to, magnetic storage, optical storage, etc. Such additional storage is illustrated in FIG. 6 by storage 620. In one aspect, computer readable instructions to implement one aspect provided herein are in storage 620. Storage 620 may store other computer readable instructions to implement an operating system, an application program, etc. Computer readable instructions may be loaded in memory 618 for execution by the at least one processing unit 616, for example.

The term “computer readable media” as used herein includes computer storage media. Computer storage media includes volatile and nonvolatile, removable, and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 612. Any such computer storage media is part of the computing device 612.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 612 includes input device(s) 624 such as keyboard, mouse, pen, voice input device, touch input device, infrared cameras, video input devices, or any other input device. Output device(s) 622 such as one or more displays, speakers, printers, or any other output device may be included with the computing device 612. Input device(s) 624 and output device(s) 622 may be connected to the computing device 612 via a wired connection, wireless connection, or any combination thereof. In one aspect, an input device or an output device from another computing device may be used as input device(s) 624 or output device(s) 622 for the computing device 612. The computing device 612 may include communication connection(s) 626 to facilitate communications with one or more other devices 630, such as through network 628, for example.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for causal graph chain reasoning predictions, comprising:
an ego-vehicle including a vehicle system;
a memory storing one or more instructions; and
a processor executing one or more of the instructions stored on the memory to perform:
generating a causal graph of one or more participants within an operating environment including the ego-vehicle, one or more agents, and one or more potential obstacles, wherein the causal graph is indicative of causal relationships between two or more of the participants within the operating environment;
generating a prediction for each participant within the operating environment based on the causal graph;
generating an action for the ego-vehicle based on the prediction for each participant within the operating environment; and
implementing, via the vehicle system and the ego-vehicle, the action generated by the processor.

2. The system for causal graph chain reasoning predictions of claim 1, wherein one or more of the agents is another vehicle, a bicycle, or a motorcycle.

3. The system for causal graph chain reasoning predictions of claim 1, wherein one or more of the potential obstacles is another vehicle, a bicycle, a motorcycle, a parked vehicle, a traffic sign, a pedestrian, an intersection, or a road feature.

4. The system for causal graph chain reasoning predictions of claim 1, wherein one or more nodes of the causal graph represent the ego-vehicle or one or more of the agents.

5. The system for causal graph chain reasoning predictions of claim 1, wherein one or more edges of the causal graph represent a causal relationship between two nodes of the causal graph.

6. The system for causal graph chain reasoning predictions of claim 5, wherein the causal relationship is a leader-follower relationship, a trajectory-dependency relationship, or a collision relationship.

7. The system for causal graph chain reasoning predictions of claim 1, wherein the prediction for each participant is an intention prediction or a trajectory prediction.

8. The system for causal graph chain reasoning predictions of claim 1, wherein the generating the prediction for each participant within the operating environment is based on a topological sort of the causal graph.

9. The system for causal graph chain reasoning predictions of claim 1, wherein the action is a warning.

10. The system for causal graph chain reasoning predictions of claim 1, wherein the action is a driving maneuver.

11. A computer-implemented method for causal graph chain reasoning predictions, comprising:
generating a causal graph of one or more participants within an operating environment including an ego-vehicle, one or more agents, and one or more potential obstacles, wherein the causal graph is indicative of causal relationships between two or more of the participants within the operating environment;
generating a prediction for each participant within the operating environment based on the causal graph;
generating an action for the ego-vehicle based on the prediction for each participant within the operating environment; and
implementing, via a vehicle system of the ego-vehicle, the action.

12. The computer-implemented method for causal graph chain reasoning predictions of claim 11, wherein one or more nodes of the causal graph represent the ego-vehicle or one or more of the agents.

13. The computer-implemented method for causal graph chain reasoning predictions of claim 11, wherein one or more edges of the causal graph represent a causal relationship between two nodes of the causal graph.

14. The computer-implemented method for causal graph chain reasoning predictions of claim 13, wherein the causal relationship is a leader-follower relationship, a trajectory-dependency relationship, or a collision relationship.

15. The computer-implemented method for causal graph chain reasoning predictions of claim 11, wherein the prediction for each participant is an intention prediction or a trajectory prediction.

16. The computer-implemented method for causal graph chain reasoning predictions of claim 11, wherein the generating the prediction for each participant within the operating environment is based on a topological sort of the causal graph.

17. A system for causal graph chain reasoning predictions, comprising:
an ego-vehicle including a vehicle system;
a memory storing one or more instructions; and
a processor executing one or more of the instructions stored on the memory to perform:
generating a causal graph of one or more participants within an operating environment including the ego-vehicle, one or more agents, and one or more potential obstacles, wherein the causal graph is indicative of the causal relationships between two or more of the participants within the operating environment;
generating an intention prediction or a trajectory prediction for each participant within the operating environment based on the causal graph;
generating an action for the ego-vehicle based on the intention prediction or the trajectory prediction for each participant within the operating environment; and
implementing, via the vehicle system and the ego-vehicle, the action generated by the processor.

18. The system for causal graph chain reasoning predictions of claim 17, wherein one or more nodes of the causal graph represent the ego-vehicle or one or more of the agents.

19. The system for causal graph chain reasoning predictions of claim 17, wherein one or more edges of the causal graph represent a causal relationship between two nodes of the causal graph.

20. The system for causal graph chain reasoning predictions of claim 19, wherein the causal relationship is a leader-follower relationship, a trajectory-dependency relationship, or a collision relationship.
